(19) United States
(12) Patent Application Publication
(10) Pub. No.: US 2017/0140065 A1
(43) Pub. Date: May 18, 2017

(54) AUTOMATED ASSISTANCE FOR FOCUSED GRAPH MANIPULATION

(71) Applicant: GOVERNMENT OF THE UNITED STATES AS REPRESENTED BY THE SECRETARY OF THE AIR FORCE, ROME, NY (US)

(72) Inventors: PATRICK J. FISHER, VERONA, NY (US); TIMOTHY M. LEBO, UTICA, NY (US); NICHOLAS R. DEL RIO, ROME, NY (US)

(21) Appl. No.: 15/197,809

(22) Filed: Jun. 30, 2016

Related U.S. Application Data
(60) Provisional application No. 62/204,161, filed on Aug. 12, 2015.

(51) Int. Cl. G06F 17/30

(52) U.S. Cl. CPC G06F 17/30958; G06F 17/30985

(57) ABSTRACT

Invention comprises computer instructions that operate on a database so as to cause the computer to perform a cyclical process that utilize a user's information focus as well as the input and output data patterns of software tools to automatically suggest sequences of tools that can create objective datasets.

### PRIORITY CLAIM UNDER 35 U.S.C. §119(e)

This patent application claims the priority benefit of the filing date of a provisional application Ser. No. 62/204,161, filed in the United States Patent and Trademark Office on Aug. 12, 2015.

### STATEMENT OF GOVERNMENT INTEREST

The invention described herein may be manufactured and used by or for the Government for governmental purposes without the payment of any royalty thereon.

### BACKGROUND OF THE INVENTION

Analysts are often unable to efficiently design and orchestrate executable sequences of software tools that can produce objective datasets and visualizations. The input and output expectations of most tools are implicit and not amenable to automated reasoning that can help analysts determine which set of tools are applicable at a given stage in an analytical process. Furthermore, an analyst's information of interest (Shneiderman 1996) is not typically captured and used as an additional constraint to reduce the set of applicable tools.

Existing approaches, which automatically orchestrate the execution of Web services (Wilkinson 2011), rely on formal documentation that is detached from the actual implementation of the tool. Other related approaches match datasets specifically to visualization tools that also mark the termination of the execution sequence (US2013/0103677A1, Mackinlay 2007), as opposed to this invention, which handles arbitrarily sized chains of functions with arbitrary domains and ranges and thus does not impose a terminal function; the process terminates when either all functions have been exhausted or when an analyst chooses to exit.

### OBJECTS AND SUMMARY OF THE INVENTION

One object of the present invention is to provide an article of manufacture for use with a computer/database system which forms what is known as a “basin”, which maintains a pairing of a dataset with a subset of that dataset.

Yet another object of the present invention is to provide an article of manufacture for use with a computer/database system that uses the subset of a basin to constrain, or “focus”, a pattern.

Yet another object of the present invention is to provide an article of manufacture for use with a computer/database system that uses an input pattern to recognize and extract a subset of a dataset from a basin.

Yet another object of the present invention is to provide an article of manufacture for use with a computer/database system that uses an output pattern to produce new datasets and/or subsets to form a basin.

The invention disclosed herein provides an article of manufacture for use with a computer/database system that leverages focus to form datasets from datasets. The present invention comprises a cyclical process and associated set of apparatuses that use an analyst's information focus as well as the input and output data patterns of software tools to automatically suggest sequences of tools that can create objective datasets. The invention relies on dual-purpose patterns that are used both to describe the data expectations of software tools as well as to perform the actual extraction and generation of datasets. In particular, this invention forms datasets through a meta-computational framework process. The process uses “functions” that combine the object that recognizes and extracts subsets with the object that produces new basins. The process establishes a basin of concern by transforming a dataset into a basin upon entering the system, or choosing an existing basin within the system. For the basin of concern, a set of functions that are applicable to it are determined. New basins that exhibit the applicable functions' output patterns are then created. The process may repeat.

According to an embodiment of the present invention, an article of manufacture comprising a non-transitory storage medium having a plurality of programming instructions stored therein configures a computer/database apparatus to determine which functions are applicable to a basin of concern by inputting patterns associated with all known functions. A constrained version of each input pattern is created using the subset of the basin of concern. A function is applicable if its constrained input pattern is a non-empty subset.

According to an embodiment of the present invention, an article of manufacture comprising a non-transitory storage medium having a plurality of programming instructions stored therein configures a computer/database apparatus to pair a dataset with a subset, called a basin, by taking in a reference to a dataset; taking in a reference to another dataset, and outputting the basin that is either the pairing of the former input and the latter input or the empty set if the latter input dataset is not a subset of the former input dataset. A single dataset can be made into a basin by applying this process to the dataset as both the former and latter inputs.

According to an embodiment of the present invention, an article of manufacture comprising a non-transitory storage medium having a plurality of programming instructions stored therein configures a computer/database apparatus to use an input pattern to recognize and extract a subset of a dataset comprises the steps of taking in a basin; using the subset of the basin to focus the pattern matching for the dataset; using the focused pattern to obtain a new subset from the dataset.

According to an embodiment of the present invention, an article of manufacture comprising a non-transitory storage medium having a plurality of programming instructions stored therein configures a computer/database apparatus to use an output pattern to produce new datasets and/or subsets by defining the output pattern, arranging a dataset to match the output pattern, and then forming a new basin from the arranged dataset.

According to a feature of the present invention, an article of manufacture comprising a non-transitory storage medium having a plurality of programming instructions stored therein, users can know in advance if a particular function can apply to their dataset. The invention leverages the object “that uses an input pattern to recognize and extract a subset of a dataset from a basin to automatically determine which functions apply and therefore can eliminate non-applicable functions from the set of all functions. The applicability searching reduces the set of functions to only those which have an input pattern that the basin exhibits. After a function executes and generates a new basin, this process occurs again and finds the functions whose input pattern is exhibited in the new basin. Users can spend less time considering all options by focusing on options that lead to something meaningful.

According to a feature of the present invention, an article of manufacture comprising a non-transitory storage medium having a plurality of programming instructions stored therein, users can know in advance if a particular series of functions, or chains, can apply to their dataset. This process matches the input pattern of one function to the output pattern of another function. The chaining process comprises of the steps of: take in a dataset; find an acceptable function that can apply; find another function that the input will match output of the last function; repeat the last step if desired.

According to a feature of the present invention, an article of manufacture comprising a non-transitory storage medium having a plurality of programming instructions stored therein, information objectives can be targeted and achieved. By using functions, users can encode information objectives as patterns they want to find within datasets. This feature of the present invention configures a computer/database to permit users to first create a dataset input pattern, whereupon the pattern is added to the database of objects that recognize and extract. The added object is considered in the Meta-Computational process.

### REFERENCES

U.S. Patent Application Publication US2013/0103677A1.
Mackinlay, J. D., Hanrahan, P., & Stolte, C. (2007). Show me: Automatic presentation for visual analysis. Visualization and Computer Graphics, IEEE Transactions on, 13(6), 1137-1144.
Shneiderman, B. (1996, September). The eyes have it: A task by data type taxonomy for information visualizations. In Visual Languages, 1996. Proceedings, IEEE Symposium on (pp. 336-343). IEEE.
Wilkinson, M. D., Vandervalk, B., & McCarthy, L. (2011). The Semantic Automated Discovery and Integration (SADI) web service design-pattern, API and reference implementation. Journal of biomedical semantics, 2(1), 1.

### BRIEF DESCRIPTION OF THE DRAWINGS

FIG. 1 depicts an example of a basin created from a single graph.

FIG. 2 depicts another example of a basin.

FIG. 3 depicts the process of extracting a subgraph using an input pattern and a basin.

FIG. 4 depicts the process of forming a graph from an output query.

FIG. 5 depicts the present invention's process for deriving basins from basins.

FIG. 6 depicts a flow chart of the present invention's process for deriving basins from basins.

### DETAILED DESCRIPTION OF THE PREFERRED EMBODIMENT

The present invention comprises non-transitory instructions which configure an apparatus, generally a computing device, to act on computer/databases and leverages focus to form datasets from datasets. The preferred embodiment uses directed labeled graphs in place of the dataset and a subgraph in place of the subset. The graphs are stored in a graph database and patterns are represented as queries which can match against subgraphs (graph pattern matching).

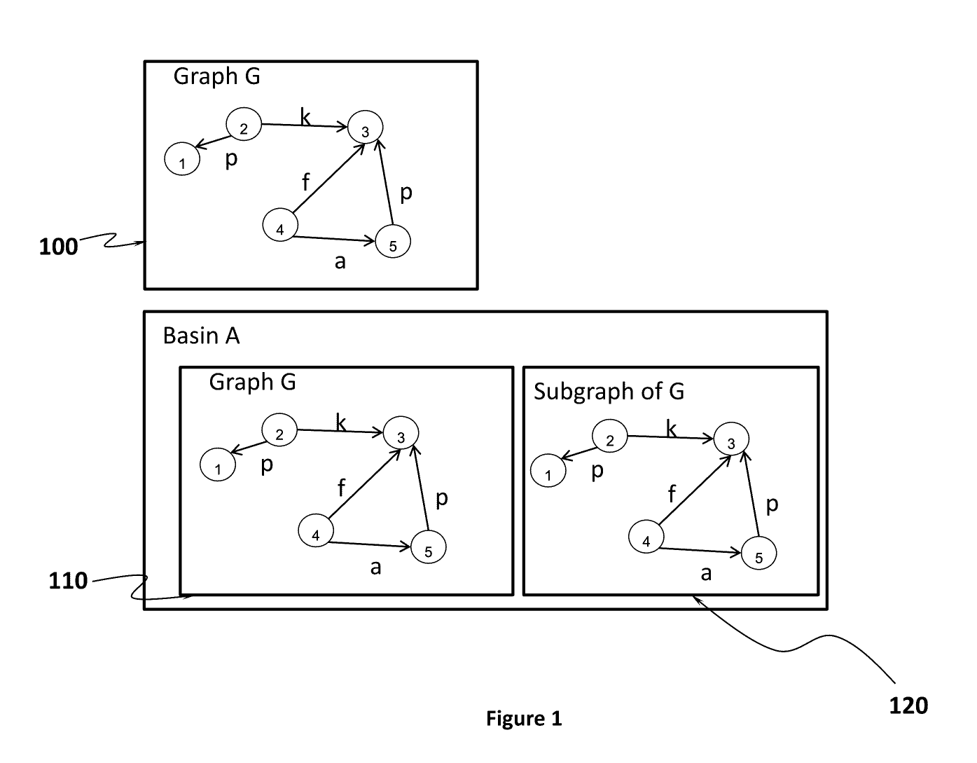

Referring to FIG. 1, the drawing shows the canonical structure of a basin, in which the basin was formed from a single Graph G 100. Graph G, where V={1,2,3,4,5} and E={(2,P,1),(2,K,3),(4,f,3),(4,a,5),(5,p,3)}, is transformed into a basin by having the graph and the subgraph of the basin be Graph G. Basin A depicts its graph and subgraph at 110 and 120 respectively. The trivial subgraph formation is all the nodes and edges within the graph and therefore V={1,2,3,4,5} and E={(2,P,1),(2,K,3),(4,f,3),(4,a,5),(5,p,3)}.

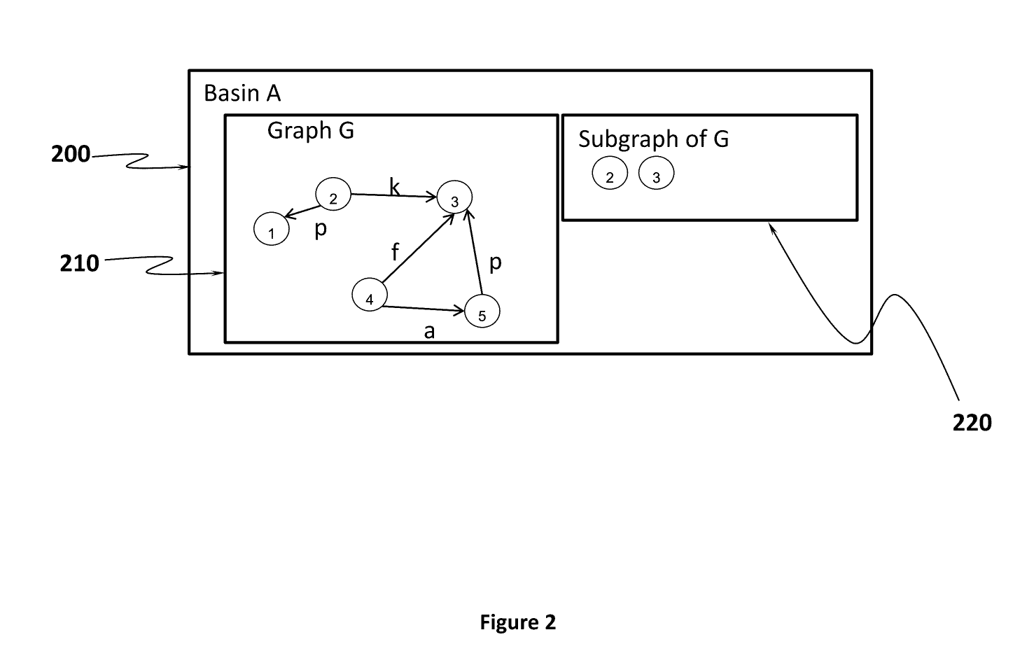

Referring to FIG. 2, the drawing shows yet another basin represented in the canonical form shown in 200. Basin A contains a graph G which is a directed label graph G=(V,E) as depicted in 210, where V={1,2,3,4,5} and E={(2,p,1),(2,k,3),(4,f, 3),(4,a,5),(5,p,3)}. 220 shows the subgraph of Basin A which is V={2,3} and E={ }; a set of unconnected vertices is mathematically still a graph.

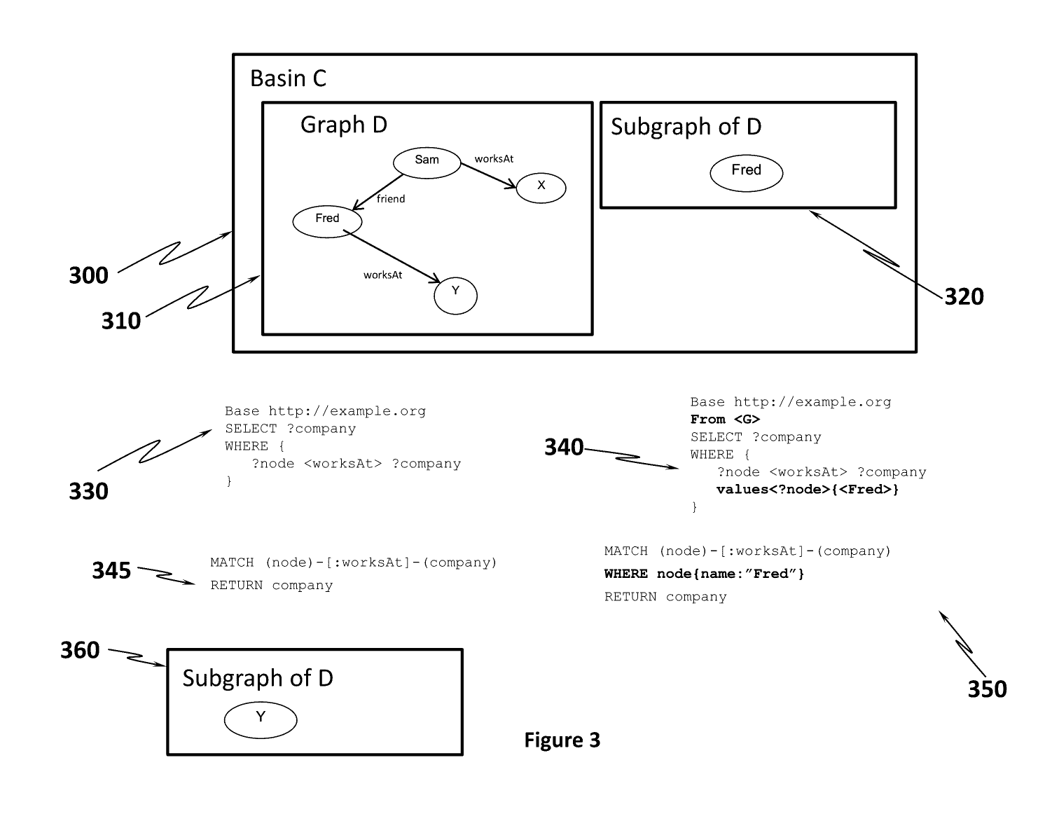

Referring to FIG. 3, the drawing shows how the input patterns are used to gather and extract subgraphs. In the preferred embodiment, SPARQL is used as the querying language to recognize and extract subgraphs represented using the Resource Description Framework (RDF). 300 depicts a basin C which has dataset graph D 310 and a corresponding subgraph of D 320. 310 shows graph D of basin C 300 where V={Fred, Sam, X, Y} and E={(Sam, friend, Fred), (Sam, workAt, X), (Fred, workAt, Y)}. 320 shows the subgraph of D of basin C 300 where V={Fred} and E={ }. In addition to basin C 300, there exists an input pattern expressed in SPARQL shown in 330. Taking the graph and subgraph of basin C 300 and the input pattern 330, a new constrained version of the input pattern is created shown in 340. The input query is constrained to graph D 310 by the addition of “From <D>” clause and constrained to the subgraph of D 320 by the addition of “values(?node){<Fred>}” clause. The focused pattern 340 is used by the graph database to extract the subgraph shown in 360. The pattern is applicable to the basin, if and only if the new subgraph produced is non-empty. Other embodiments of the present invention might use other graph querying languages, such as the Cypher query language, to recognize and extract subgraphs. 345 shows the input pattern represented in Cypher and 350 shows the focused input pattern. When executed, the focused Cypher query will result in the same subgraph as shown in 360.

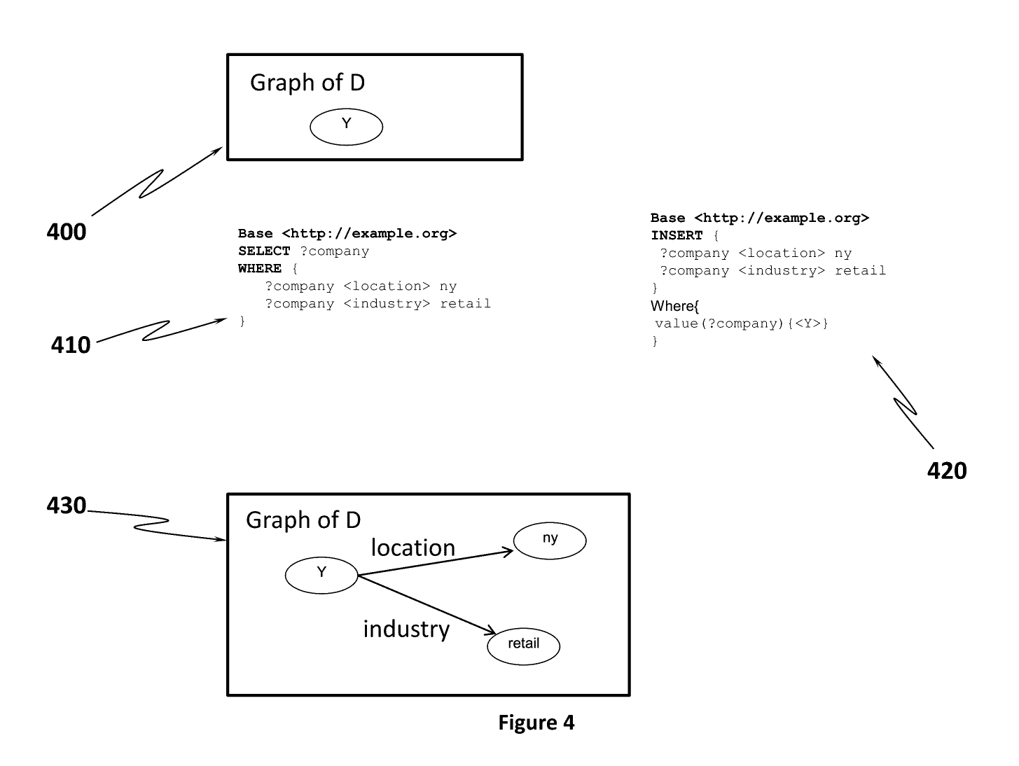

Referring to FIG. 4, the drawing shows a detailed example of an output pattern. In the preferred embodiment, the output pattern used to produce new datasets or basins is expressed in SPARQL. In the preferred embodiment, the output query is used to form a new insert query by placing the graph pattern found in the “where” clause into the “insert” clause of the new query. The insert pattern is constrained by some graph, such as 400, and processed. For example, 410 shows an insert clause that is constrained by the graph D 400 using “value<?company>{Y}” clause. The graph that results from processing the example insert query is shown in 420, which fulfills the output pattern of 410. The graph 430 can be trivially turned into a basin by using that same graph as the subgraph or an arbitrary subgraph of 430 can be chosen.

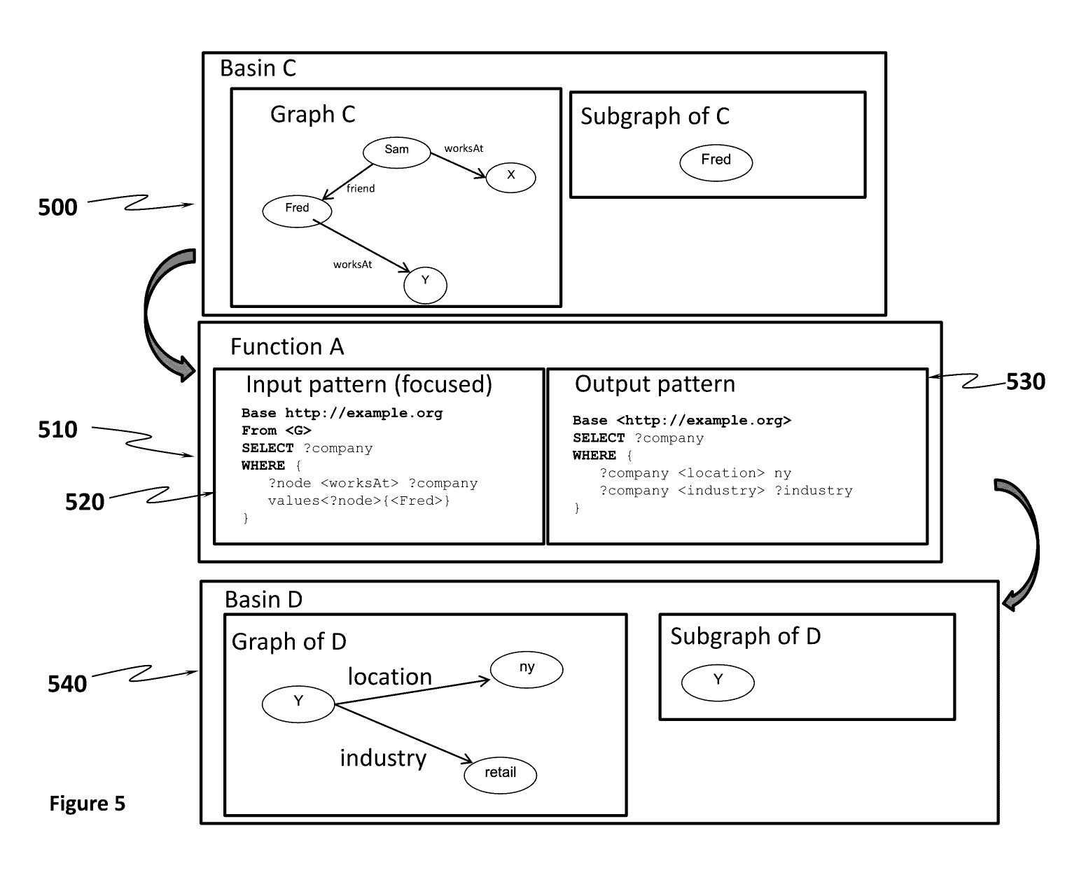

Referring to FIG. 5, the drawing shows the function's role in the invention's process from which a new basin D 540 is derived from an existing basin C 500. Basin C, shown in 500, is acceptable by Function A, shown in 510, which combines the SPARQL input and output patterns, shown at 520 and 530 respectfully. The function outputs basin D, shown in 540, whose graph matches the function's output pattern 530.

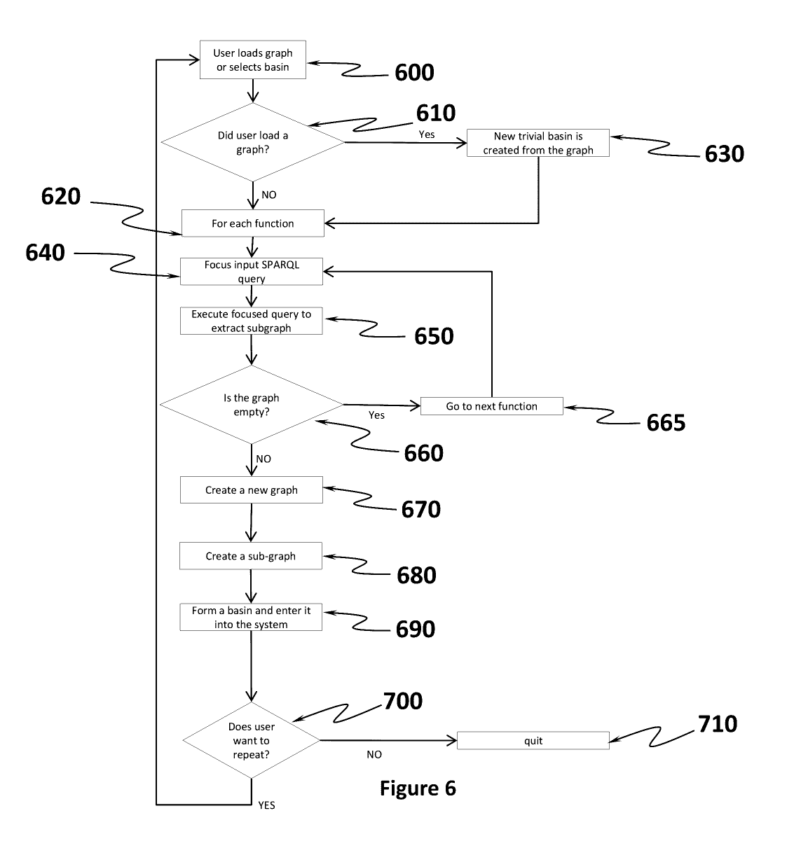

Referring to FIG. 6, the drawing shows the steps the present invention configures a computer/database apparatus to perform. In the preferred embodiment, users establish a basin of interest by loading a graph or selecting a basin that already exists in the system 600. If a graph was loaded 610, then a trivial basin is formed from the graph as the subgraph 630. Once the basin of interest is established, all functions are gathered 620. Each function's input SPARQL query is focused using the basin of interest 640. The focused query is used by the graph database to extract a subgraph 650. If the graph is empty 660, the process considers another function 665. Otherwise a new graph and subgraph are created 670, 680. A basin is formed from these two graphs and entered into the system 690. The remaining functions are then considered until all have been processed. The user then chooses to repeat the process 700 or quit 710.

What is claimed is:

1. An article of manufacture comprising a non-transitory storage medium having a plurality of programming instructions stored therein, said programming instructions being configured to program an apparatus to implement a sequence of steps, comprising:
loading either one of a user selected graph or preexisting basin;
determining whether a graph or preexisting basin was loaded;
forming a trivial basin from a graph when a graph is loaded;
gathering functions;
focusing each said functions' input query using said trivial basin;
extracting a subgraph from a database corresponding to said graph using said focused input query;
selecting another function and reattempting to extract a subgraph when said graph is empty;
creating a new graph and subgraph when said graph is not empty;
forming a basin from said graph and subgraph; and
selecting remaining said functions for processing in aforesaid sequence of steps.

2. The article of manufacture of claim 1, wherein said input query is a SPARQL language query.

3. The article of manufacture of claim 1, wherein said apparatus is a computing device.

4. An article of manufacture comprising a non-transitory storage medium having a plurality of programming instructions stored therein, said programming instructions being configured to program an apparatus to implement a sequence of steps upon a database, comprising:
identifying a basin formed from a dataset and data subset pair of concern;
determining functions that are applicable to said basin; and
creating new basins exhibiting the output patterns of said functions.

5. The article of manufacture of claim 4, wherein said programming instructions configured to program an apparatus to implement the step of determining further comprise programming instructions configured to program said apparatus to:
retrieve input patterns associated with all known functions; and
create a constrained version of each said input pattern using a subset of a basin of concern.

6. The article of manufacture of claim 4, wherein said programming instructions configured to program an apparatus to implement the step of identifying further comprise programming instructions configured to program said apparatus to:
input a reference to a first dataset;
input a reference to a second dataset;
output a basin that comprises a pairing of said first and said second dataset; and
output an empty set when said second dataset is not a subset of said first dataset.

7. The article of manufacture of claim 4, wherein said programming instructions configured to program an apparatus to implement the step of creating new basins further comprise programming instructions configured to program said apparatus to:
input a basin using a subset of said basin;
focus pattern matching for said dataset; and
use said focused pattern to extract a new subset from said dataset.

8. The article of manufacture of claim 4, wherein said programming instructions configured to program an apparatus to implement the step of creating new basins further comprise programming instructions configured to program said apparatus to:
define an output pattern;
arrange a dataset to match said output pattern; and
form a new basin from said arranged dataset.

9. The article of manufacture of claim 4, wherein said programming instructions further comprise programming instructions configured to program said apparatus to encode information objectives by:
creating a dataset input pattern;
adding said pattern to a database of objects that recognize and extract; and
considering said added object in a meta-computational process.
